(19) United States
(12) Patent Application Publication
(10) Pub. No.: US 2017/0282601 A1
(43) Pub. Date: Oct. 5, 2017

(54) ADJUSTABLE S-ROLLERS IN A PRINT SYSTEM

(71) Applicants: Stuart J. Boland, Denver, CO (US); Dilan Nirushan Fernando, Thornton, CO (US); Robert F. Jessen, Berthoud, CO (US)

(72) Inventors: Stuart J. Boland, Denver, CO (US); Dilan Nirushan Fernando, Thornton, CO (US); Robert F. Jessen, Berthoud, CO (US)

(73) Assignee: Ricoh Company, Ltd., Tokyo (JP)

(21) Appl. No.: 15/088,845

(22) Filed: Apr. 1, 2016

(51) Int. Cl. B41J 13/00; B65H 43/00; G06F 3/12; B65H 20/02; G06K 15/02; G06K 15/00

(52) U.S. Cl. CPC B41J 13/0009; G06K 15/022; G06K 15/4025; G06K 15/4065; G06F 3/1231; G06F 3/1258; B65H 20/02; B65H 43/00; B41J 2/01

(57) ABSTRACT

Systems and methods for adjustable S-rollers in a print system. One system is an apparatus that includes a pair of rollers configured to be positioned on opposite sides of a web of continuous-forms print media, and a coupling member that connects the pair of rollers, wherein the coupling member pivots about a common axis between the pair of rollers. The apparatus also includes a drive unit configured to pivot the coupling member and a controller to receive input that describes at least one property of the web, and to direct the drive unit to pivot the coupling member to a position that applies a normal force between the web and at least one of the pair of rollers based on the at least one property of the web.

### FIELD OF THE INVENTION

The invention relates to the field of printing and web handling systems.

### BACKGROUND

Businesses or other entities having a need for volume printing typically use a production printer capable of printing hundreds of pages per minute. A web of print media, such as paper, is stored the form of a large roll and unwound as a continuous sheet. During printing, the web is quickly passed underneath printheads which discharge small drops of ink at particular intervals to form pixel images on the web.

At some point, a print shop operator may change the print media (e.g., to a paper having a different thickness, gloss, width, etc.) by splicing the new web to an end of the continuous sheet and conveying the new web through the rollers of the print system so that it is positioned underneath the printheads. However, differences in media properties of the new web may alter the web handling performance in the print system as compared to the previous web. Improper web handling control may cause the web to lose its alignment during printing, leading to pixel distortions in the printed job and decreased print quality. Also, improper web handling control may cause physical damage to the web such as shrinking, stretching, excessive drying, tearing, curling, baggy edges, wrinkling, or other structural deformations to the web that degrade the printed document quality.

### SUMMARY

Embodiments described herein provide for adjustable S-rollers in a print system. A series of rollers transport a web of media as the media travels in a printing system. At least one of these rollers is an S-roller unit that includes two rollers connected to one another. The web weaves through the two rollers so that it wraps around the top of one roller and wraps around the bottom of the other roller. The two rollers may be electronically and/or mechanically controlled to circle around together to increase or decrease the amount of weaving in the web to apply a desirable level of web control during printing.

One embodiment is an apparatus that includes a pair of rollers configured to be positioned on opposite sides of a web of continuous-forms print media, and a coupling member that connects the pair of rollers, wherein the coupling member pivots about a common axis between the pair of rollers. The apparatus also includes a drive unit configured to pivot the coupling member and a controller to receive input that describes at least one property of the web, and to direct the drive unit to pivot the coupling member to a position that applies a normal force between the web and at least one of the pair of rollers based on the at least one property of the web.

The above summary provides a basic understanding of some aspects of the specification. This summary is not an extensive overview of the specification. It is not intended to identify key or critical elements of the specification nor to delineate any scope of particular embodiments of the specification, or any scope of the claims. Its sole purpose is to present some concepts of the specification in a simplified form as a prelude to the more detailed description that is presented later. Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates an exemplary continuous-forms printing system.

FIG. 2 illustrates printing system with an S-roller in an exemplary embodiment.

FIG. 3 illustrates a method for adjusting an S-roller of printing system in an exemplary embodiment.

FIGS. 4A-F illustrate an S-roller at various rotation positions.

FIG. 5 illustrates an S-roller configuration in a drying system of a printing system in an exemplary embodiment.

FIG. 6 illustrates a processing system operable to execute a computer readable medium embodying programmed instructions to perform desired functions in an exemplary embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

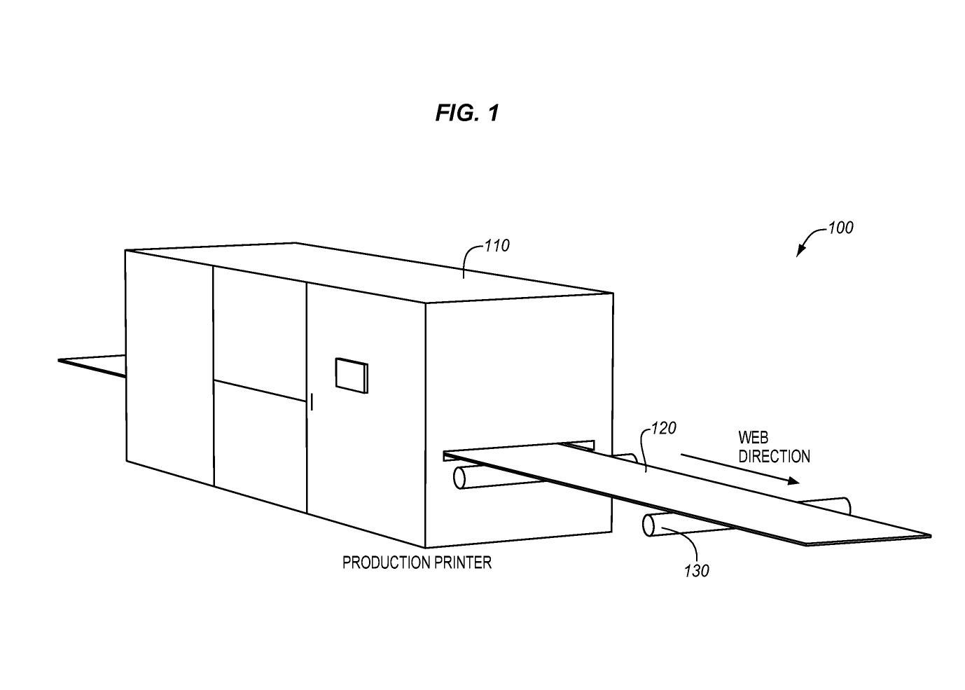

FIG. 1 illustrates an exemplary continuous-forms printing system 100. Printing system 100 includes production printer 110, which is configured to apply ink onto a web 120 of continuous-form print media (e.g., printable substrates made of paper, plastic, metal, textile, fabric, etc.). As used herein, the word “ink” is used to refer to any suitable marking fluid (e.g., aqueous inks, oil-based paints, primer coat, protector coat, gloss coat, etc.). Printer 110 may comprise an inkjet printer that applies colored inks, such as Cyan (C), Magenta (M), Yellow (Y), Key (K) black, white, or clear inks. Printing system 100 includes one or more guide rollers 130 that are fixed in place to position web 120 as it travels through printing system 100.

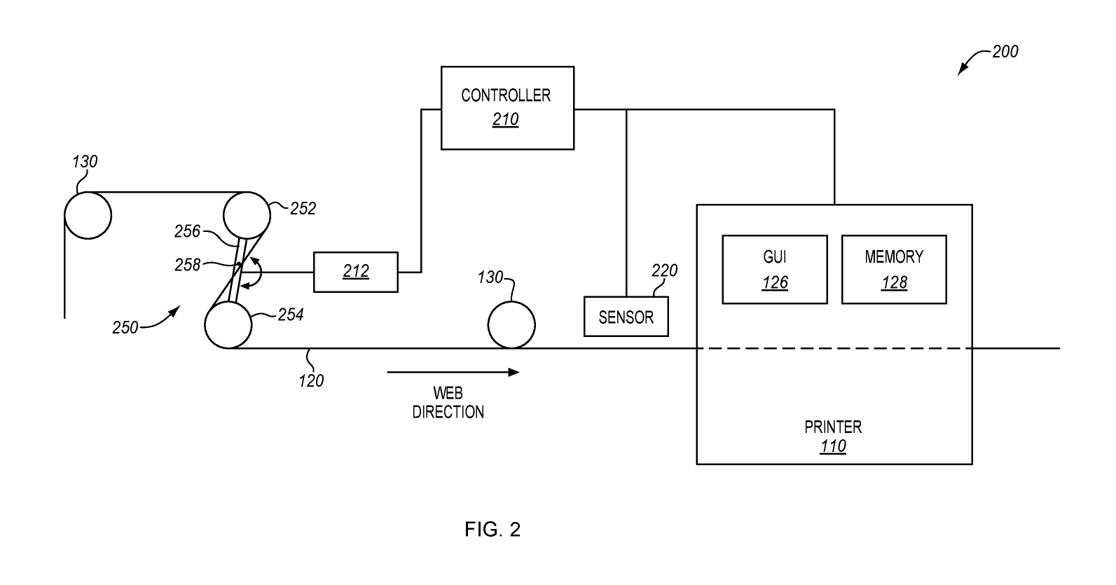

FIG. 2 is a block diagram illustrating a printing system 200 with an S-roller 250 in an exemplary embodiment. S-roller 250 is any system, component, or device configured to guide web 120 between at least two angled surfaces offset in a traveling direction of web 120 and arranged to contact opposite sides of web 120. As the name implies, S-roller 250 may cause web 120 to curve and form an S-shaped path. In the example shown in FIG. 2, S-roller 250 includes a first roller 252 that contacts a back side of web 120, a second roller 254 that contacts a front side of web 120, and a coupling member 256 that connects rollers 252/254 for pivoting about a common rotation axis 258.

In general, the configuration of an S-roller may provide a desirable level of web handling control to achieve desired tension, tracking, and stability for a particular type of web (e.g., a thin web, a narrow web, a perforated web, etc.). However, the same configuration may provide undesirable control for a different type of web (e.g., a thick web, a wide web, a non-perforated web, etc.). Improper web tracking can cause the web to wander in a lateral direction that is orthogonal to the web 120 direction of travel (i.e., in the process direction). This lateral oscillation may reverberate throughout the print system and reduce the quality of the printed output on the web (e.g., misregistration of printed marks or misregistration of finishing operations such as slitting, cutting, rewinding, etc.). Improper web tension may also reduce the quality of the printed output on the web or cause the web to wrinkle or break. In previous print systems, the S-roller configuration is fixed. Thus, a change in web media type in the print system may require a print shop operator to undertake the time consuming manual task of rethreading the web through the print system so that the S-roller is bypassed or not bypassed.

Printing system 200 is enhanced with a controller 210 configured to direct a drive system 212 to pivot the position of S-roller 250 according to a desired level of engagement for web 120. Controller 210 may be communicatively coupled with a drive system 212 which comprises any suitable arrangement of components and devices operable to pivot S-roller 250 about rotation axis 258. Drive system 212 may comprise a pneumatic device, a hydraulic device, a motor, an electric linear or rotational actuator, and/or one or more shafts to push/rotate first roller 252, second roller 254, coupling member 256, or some combination thereof. Drive system 212 may provide a positional displacement or apply a force. Drive system 212 may include feedback position sensors (e.g., linear or rotational displacement, rotational encoders, etc.) or force sensors for feedback.

Controller 210 may also be communicatively coupled with sensor 220 which is any system, component, or device operable to detect and provide a level of tension in web 120. Sensor 220 may comprise a laser, pneumatic, photoelectric, ultrasonic, infrared, optical, or any other suitable type of sensing device. Sensor 220 may be located downstream or upstream from S-roller 250 in a feedback and/or feedforward system as desired.

Controller 210 may further be communicatively coupled with printer 110 and its components, such as a Graphical User Interface (GUI) 126 and/or memory 128. Controller 210 may alternatively have its own GUI 126 and/or memory 128. GUI 126 may receive operator input or instructions for directing controller 210. GUI 126 may also display graphics and/or text that show or describe a current configuration of S-roller 250 and one or more configurations of S-roller 250 available for selection. Memory 128 may store information that relates to a desired level of tension in web 120, rotation position of S-roller 250, or force applied to S-roller 250. For example, memory 128 may store a history profile that correlates at least one a web type or at least one web property with a tension of web 120, a rotation position of S-roller 250, or a force applied to S-roller 250. Controller 210 may automatically pivot S-roller 250 to a position based on input to GUI 126 and/or information stored in memory 128. The web engagement and resulting web control may be provided by the position (e.g., rotation or angle) of S-roller 250 and may be regulated by further adjustments to the rotation position of S-roller 250 or the force applied to S-roller 250.

Controller 210 advantageously pivots S-roller 250 to a position that engages web 120 an appropriate amount without manual intervention. This eliminates the need to manually rethread a web through printing system 200 if a web with different properties is used and also saves time and print resources that may otherwise be used to experimentally adjust web tension until a desirable level is achieved.

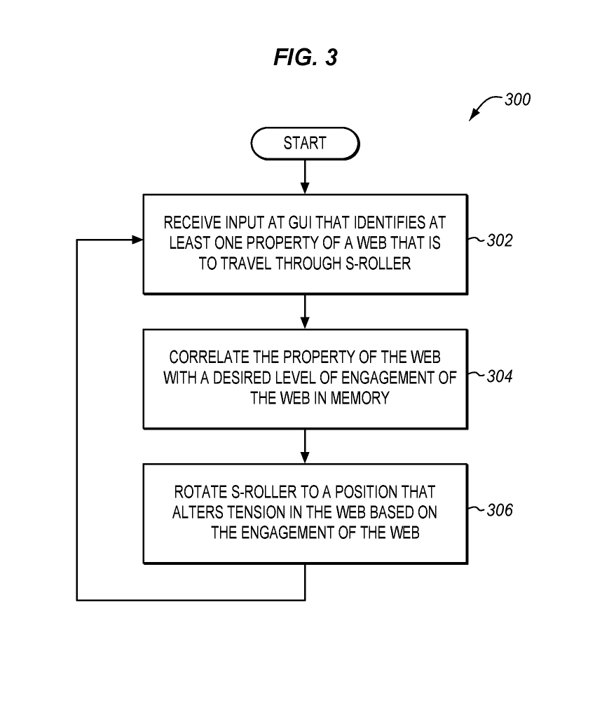

The particular arrangement, number, and configuration of components described herein is exemplary and non-limiting. Illustrative details of the operation of printing system 200 will be discussed with regard to FIG. 3, which describes a method 300 for adjusting an S-roller of printing system 200 in an exemplary embodiment. Although described with reference to printing system 200, it will be appreciated that the steps of method 300 may be performed in other systems. Additionally, the steps are not inclusive and may include other steps not shown and may also be performed in an alternative order.

In step 302, GUI 126 receives input that identifies at least one property of web 120 that is to travel through S-roller 250. A property of a web of print media may include, for example, a name for the media, a thickness, a basis weight, a stiffness, a tension, a width, a color, a perforation type, a material, a construction, a surface finish (e.g., gloss or matte), a moisture content, a tear strength, a porosity, etc. In step 304, memory 128 correlates the property of the web with a desired level of engagement or tension for that web. Then, in step 306, controller 210 directs drive system 212 to pivot S-roller 250 to a position that alters the engagement of web 120 based on one or more properties of web 120. Steps 302-306 may be continually performed to adjust engagement of web 120 in printing system 200 in accordance with web media changes for printing. The regulation of the previously mentioned web engagement may be open loop or closed loop. Closed loop feedback control from sensors (e.g., position, tension, or force sensors) may be incorporated using feedback control methods.

Alternatively or additionally, GUI 126 may receive input that identifies at least one property of printing system 100. A property of printing system 100 may include, for example, a property of a web media 120, a property of rollers 252/254, a property of the operation of printing system 100, etc. An operational property of the printing system 100 may include, for example, a web speed in the process direction, an acceleration of the web, a mode (running, stopped, accelerating, decelerating, drying, etc.), an applied ink coverage to web 120, an ambient temperature, an ambient humidity level, a dryer temperature, etc.

Controller 210 may pivot S-roller 250 using a lookup table in memory 128 that associates at least one property with a desired level of web engagement during printing. The desired level of engagement may comprise a predefined angle (e.g., wrap angle or positon angle) of S-roller 250 (e.g., input by a user at GUI 126 and stored in a history profile for the web). Alternatively or additionally, controller 210 may calculate/determine an angle of S-roller 250 based on one or more values that indicate a desired engagement amount or may calculate/determine a force for drive system 212 to apply to S-roller 250. Controller 210 may also direct drive system 212 based on one or more properties of S-roller 250 stored in memory 128. For example, controller 210 may calculate and/or direct S-roller 250 to a level of web engagement (e.g., position of S-roller 250 or force applied to S-roller 250) based at least in part on a diameter of one or more rollers 252/254 of S-roller 250, a spacing distance between rollers 252/254 in the traveling direction of web 120, and/or a material of rollers 252/254. Additional examples of a property of rollers 252/254 or an S-roller 250 include a rotational drag (e.g. freely spinning, locked from spinning, or a value that indicates spin resistance), a physical profile (e.g. shape along the roller axis is flat or constant, narrower in the middle than the ends, narrower at the ends than the middle or other shape profiles, etc.), a surface (e.g. smooth, rough, grooved, or some combination of surface textures), a construction material(e.g. metal, plastic, ceramic, rubber, or some combination of materials), a roller temperature (e.g. surface or core temperature), a roller diameter, and a wrap angle or engagement level of S-roller 250.

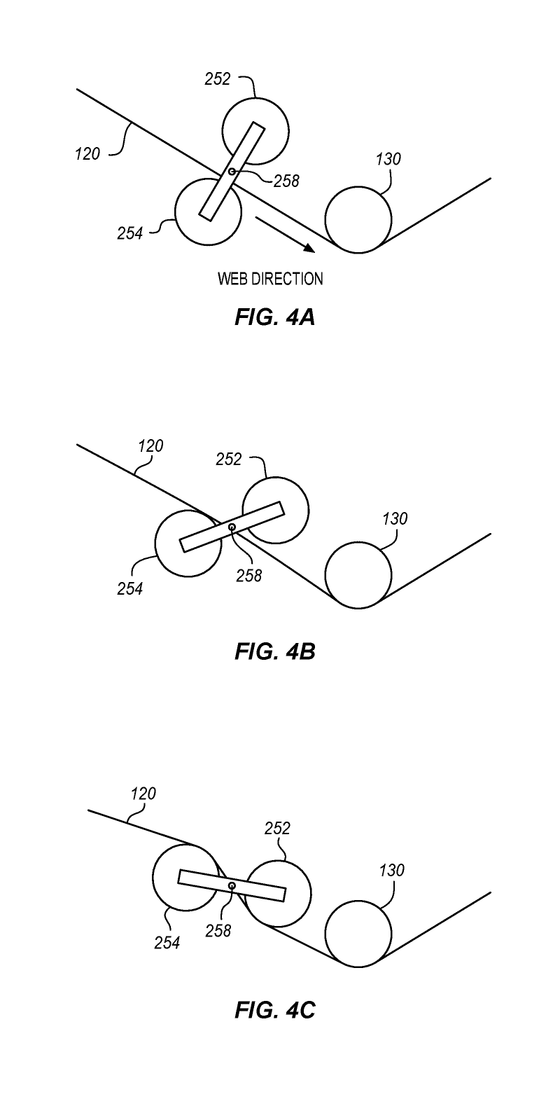

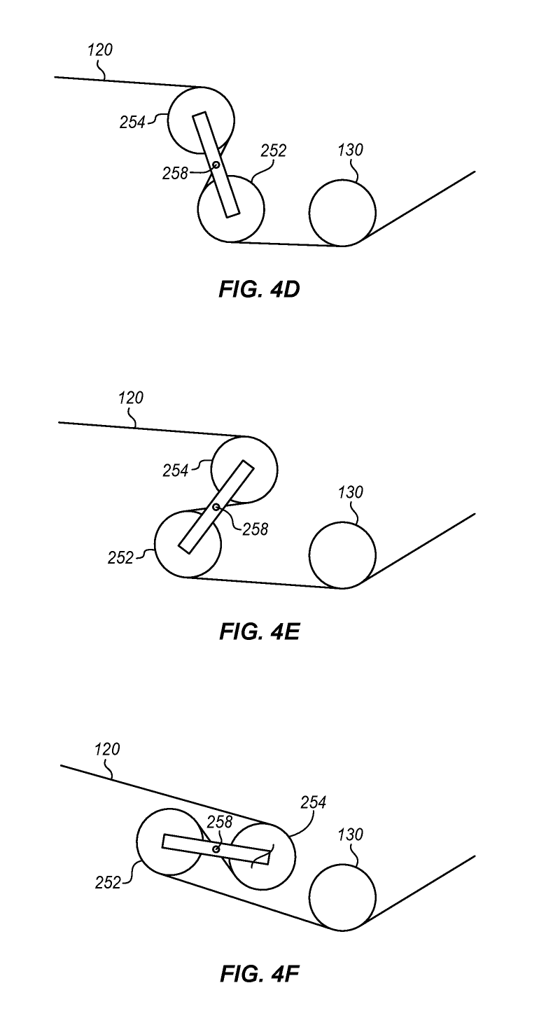

FIGS. 4A-F illustrate an S-roller 250 at various rotation positions. Assume, for this example, that controller 210 directs drive system 212 to pivot S-roller 250 about axis 258. Further assume that S-roller 250 includes a first roller 252 and a second roller 254 positioned upstream from the printheads of printer 110 and that printing system 200 also includes one or more guide rollers 130.

At the position shown in FIG. 4A, also referred to herein as a bypass (i.e., disengaged) position, web 120 travels between rollers 252/254 without contacting rollers 252/254. Here, first roller 252 is positioned a vertical distance above web 120 with respect to the direction of web travel and second roller 254 is positioned a vertical distance below web 120 with respect to the direction of web travel. In this example, web 120 travels through S-roller 250 at position between axis 258 and second roller 254 when S-roller 250 is in the bypass position. However, it will be appreciated that alternative bypass configurations are possible, including web 120 traveling through a center point between rollers 252/254 or closer to first roller 252 in the bypass position.

Controller 210 may direct S-roller 250 to the bypass position in response to input that indicates to exclude S-roller 250 from use during printing on web 120. For example, controller 210 may determine that web 120 exceeds a threshold thickness or stiffness such that it is not compatible with S-roller 250. Alternatively or additionally, controller 210 may direct drive system 212 to position S-roller 250 into the bypass position responsive to a determination that transportation of web 120 is to halt or that a period of non-printing is to occur (e.g., to prevent curling of web 120 when web 120 is stationary in printing system 200) or in response to a determination that a maintenance procedure is to be performed on printing system 200.

Controller 210 may determine to engage web 120 with S-roller 250 to varying degrees based on a received input as previously described. FIG. 4B illustrates a first level of S-roller 250 engagement in an exemplary embodiment. Controller 210 may direct drive system 212 to pivot S-roller 250 about rotation axis 258 a first amount from the bypass positon in a clockwise direction. In this example, second roller 254 contacts an underside of web 120 while a top side of web 120 continues to travel a non-zero distance below first roller 252. S-roller 250 therefore provides an incremental increase in engagement degree in web 120 at the first engagement level as compared to the bypass position.

FIG. 4C illustrates a second level of S-roller 250 engagement in an exemplary embodiment. Controller 210 may direct drive system 212 to further rotate S-roller 250 in the clockwise direction so that an increased circumferential portion of second roller 254 contacts the underside of web 120 as compared to the first level of engagement. Additionally, in this example, first roller 252 contacts a top side of web 120 at the second engagement level at a position downstream from second roller 254 in the travelling direction of web 120. S-roller 250 therefore provides an engagement level for web 120 that is increased as compared to the first level of engagement as web 120 interleaves between first roller 252 and second roller 254.

FIG. 4D illustrates a third level of S-roller 250 engagement in an exemplary embodiment. As S-roller 250 is further rotated in the clockwise direction the wrap angle of web 120 around first roller 252 and second roller 254 is increased. The wrap angle refers to the total of the angles of surface contact that rollers 252/254 have with web 120. In this example, the third level of engagement positions S-roller 250 such that approximately one quarter of the circumference of each roller 252/254 contacts web 120 to each impart a wrap angle of approximately ninety degrees. The increased wrap angle may increase tension in web 120 compared to the second level of engagement.

Increasing the wrap angle may have several effects. Firstly, if the ends of web 120 beyond S-roller 250 are held with opposing forces, the increase in wrap angle may impart a corresponding increase in tension of web 120 if at least one of rollers 252/254 is fixed or spins slower than a speed of web 120 in the process direction. An end of web 120 may have a force applied to it by difference devices or combination of devices such as nip rollers, drive rollers, dancer rollers, etc. Furthermore, controller 210 may control a tension value of web 120 (e.g., force) at the input of S-roller 250 and a speed value of web 120 (e.g., meters/minute) at the output of S-roller 250 to impart an increase in tension in web 120 due to at least a travelling friction of web 120 as it travels across rollers 252/254 of S-roller 250. Controller 210 may also direct drive system 212 to move S-roller 250 to a position that corresponds with a normal force between web 120 and surfaces of rollers 252/254. Thus, an increased wrap angle of web 120 in S-roller 250 may also cause a higher normal force between web 120 and surfaces of rollers 252/254 with a tension of web 120 remaining constant. The normal force and the coefficient of friction between web 120 and rollers 252/254 may result in frictional force in the lateral direction that oppose web 120 from moving laterally on the rollers 252/254 and may also result in frictional force in the process direction to cause further tension in web 120 in the process direction. This frictional force in the process direction may be minimal if rollers 252/254 are free to spin and may be maximized for rollers 252/254 that are fixed and unable to spin.

FIG. 4E illustrates a fourth level of S-roller 250 engagement in an exemplary embodiment. And FIG. 4F illustrates a fifth level of S-roller 250 engagement in an exemplary embodiment. As S-roller 250 is further rotated about rotation axis 258 a corresponding engagement or tension increase in web 120 is achieved in printing system 200. Controller 120 may direct S-roller 250 to rotate in the reverse direction to decrease engagement or tension in web 120. It will be appreciated that directions shown and described herein are for discussion purposes and that alternative configurations and directions may be implemented by matter of design choice. Furthermore, controller 210 may direct S-roller 250 to any number of different incremental engagement positions.

In one embodiment, controller 210 is configured to detect a tension of web 120 (e.g., based on feedback resistance of drive system 212 or feedback of sensor 220) and direct rotation of S-roller 250 based on a difference in a measured tension level and a desired tension level for web 120 stored in memory 128. Alternatively or additionally, controller 210 may be configured to detect a rotation angle/position of S-roller 250 and correlate an S-roller 120 position with a level of tension for web 120 based on one or more variables stored in memory 128.

Printing system 200 may include multiple S-rollers 250. Each S-roller 250 may be placed in printing system 200 consecutively along the direction of travel of web 120. Alternatively or additionally, S-rollers 250 may be positioned throughout printing system 200 as desired (e.g., upstream/downstream from printheads of printer 110, internal/external to housing of printer 110, etc.). Controller 210 may collectively or independently control the rotation position of each S-roller 250 in printing system 200 based on media properties, individual S-roller 250 properties or location in printing system 200, settings or operational properties of printing system 200 stored in memory 128, or various combinations of properties.

S-roller 250 may comprise numerous configurations. For example, rollers 252/254 may comprise a cylindrical shape with a circular circumference curvature or may comprise alternative shapes or number of rollers. Rollers 252/254 may also comprise any arrangement of driven, idle, or non-spinning rollers (also referred to as S-bars). Additionally, coupling member 256 may mechanically couple to rollers 252/254 in a variety of configurations. In one embodiment, coupling member 256 comprises a frame that connects rollers 252/254 at one or both longitudinal ends thereof which pivots about its approximate center via a pin or bar that extends in the lateral direction. In another embodiment, coupling member 256 comprises a ring that connects rollers 252/254 and rotates or which includes rails that enable rollers 252/254 to slide around the ring. In any case, rollers 252/254 of S-roller 250 may rotate about a common rotation axis 258 in the same rotation direction at a fixed distance from one another and may also spin in their own axis in opposite directions relative to one another as web 120 travels through S-roller 250 (e.g. S-roller 250 rotates clockwise about rotation axis 258 and first roller 252 spins clockwise as second roller 254 spins counter clockwise in FIGS. 4C-4F).

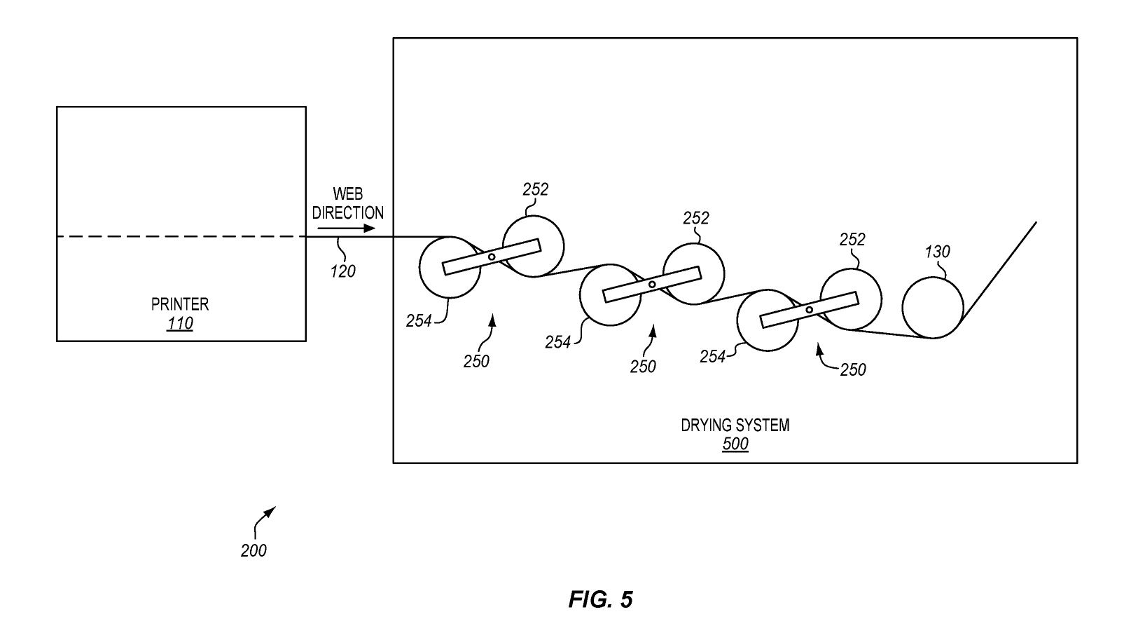

FIG. 5 illustrates an S-roller 250 configuration in a drying system 500 of printing system 200 in an exemplary embodiment. In this example, drying system 500 includes a series of S-rollers 250 along the travelling (i.e., process) direction of web 120. Assume, for this example, that the second roller 254 of each S-roller 250 of FIG. 5 is a heated roller, although it will be appreciated that rollers 252/254 may heated, cooled, or ambient in temperature in any number of combinations to provide desired conditioning of web 120. Heated rollers may include a radiant energy source disposed inside a hollow circumference of rollers 252/254 and/or disposed outside an external surface of rollers 252/254. One example of a radiant energy source is one or more heat lamps that emit infrared (IR) or near-infrared (NIR) energy and heat. Alternatively or additionally, controller 210 may be configured to direct the heating or cooling of rollers 252/254 to heat or cool web 120.

During operation, web 120 is marked with ink by printer 110 and enters drying system 500. Controller 210 directs drive system 212 to position one or more S-rollers 250 to a rotation position to cause a corresponding amount of contact with heated rollers and thus a corresponding transfer of thermal energy to web 120. A high degree of control for drying web 120 is possible (e.g., in comparison to a single drum dryer) since surfaces of S-rollers 250 may be heated separately to various temperatures. Controller 210 may be configured to retrieve information regarding which rollers are heated, ambient, or cooled to controllably adjust the rate at which web 120 is heated and/or cooled in drying system 500. Controller 210 may direct position of S-rollers 250 based on a variety of variables and configurations as already previously discussed.

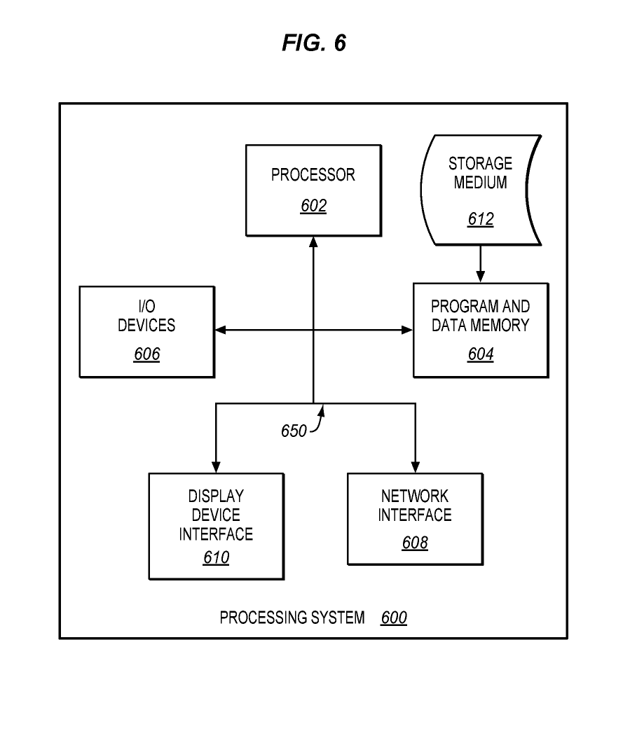

Embodiments disclosed herein can take the form of software, hardware, firmware, or various combinations thereof. In one particular embodiment, software is used to direct a processing system of printing system 200 to perform the various operations disclosed herein. FIG. 6 illustrates a processing system 600 operable to execute a computer readable medium embodying programmed instructions to perform desired functions in an exemplary embodiment. Processing system 600 is operable to perform the above operations by executing programmed instructions tangibly embodied on computer readable storage medium 612. In this regard, embodiments of the invention can take the form of a computer program accessible via computer-readable medium 612 providing program code for use by a computer or any other instruction execution system. For the purposes of this description, computer readable storage medium 612 can be anything that can contain or store the program for use by the computer.

Computer readable storage medium 612 can be an electronic, magnetic, optical, electromagnetic, infrared, or semiconductor device. Examples of computer readable storage medium 612 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 600, being suitable for storing and/or executing the program code, includes at least one processor 602 coupled to program and data memory 604 through a system bus 650. Program and data memory 604 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 606 (including but not limited to keyboards, displays, pointing devices, etc.) can be coupled either directly or through intervening I/O controllers. Network adapter interfaces 608 may also be integrated with the system to enable processing system 600 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 610 may be integrated with the system to interface to one or more display devices, such as printing systems and screens for presentation of data generated by processor 602.

Although specific embodiments were described herein, the scope of the invention is not limited to those specific embodiments. The scope of the invention is defined by the following claims and any equivalents thereof.

We claim:

1. An apparatus comprising:
a printer configured to apply ink to a web of continuous-forms print media;
a first pair of rollers configured to be positioned on opposite sides of the web;
a first coupling member to connect the first pair of rollers, wherein the first coupling member pivots about a first common axis between the first pair of rollers;
a first drive unit configured to pivot the first coupling member;
a second pair of rollers configured to be positioned on the opposite sides of the web;
a second coupling member to connect the second pair of rollers, wherein the second coupling member pivots about a second common axis between the second pair of rollers;
a second drive unit configured to pivot the second coupling member;
a graphical user interface of the apparatus to receive input identifying a media type among a plurality of media types for the web; and
a controller to direct the first drive unit to pivot the first coupling member to a first position among a first plurality of positons, and to direct the second drive unit to pivot the second coupling member to a second position among a plurality of second positions based on the media type identified at the graphical user interface of the apparatus;
wherein when the first pair of rollers are in the first position the first pair of rollers do not contact the web, and when the second pair of rollers are in the second position the second pair of rollers contact the web.

2-20. (canceled)

21. The apparatus of claim 1 further comprising:
a heating unit configured to apply heat to the first pair of rollers;
wherein the first pair of rollers are positioned downstream from printheads of the printer to dry ink applied to the web; and
wherein the second pair of rollers are unheated.

22. The apparatus of claim 1 wherein the media type includes a media thickness.

23. The apparatus of claim 1 wherein the media type is identified by a media name.

24. The apparatus of claim 1 wherein the media type is identified by a material.

25. The apparatus of claim 1 wherein the physical properties of the first pair of rollers are different than physical properties of the second pair of rollers.

26. The apparatus of claim 1 wherein a diameter of the first pair of rollers is different than a diameter of the second pair of rollers.

27. The apparatus of claim 1 wherein a surface texture of the first pair of rollers is different than a surface texture of the second pair of rollers.

28. The apparatus of claim 1 wherein the controller directs the first drive unit based on a first property of the first pair of rollers stored in memory, and directs the second drive unit based on a second property of the second pair of rollers stored in memory, wherein the first property and the second property are different.

29. A method comprising:
receiving input at a graphical user interface of a printing system that identifies a media type for a web of continuous-forms print media that is to travel through a first pair of rollers positioned on opposite sides of the web and a second pair of rollers positioned on the opposite sides of the web, the first pair of rollers connected via a first coupling member that pivots about a first common axis between the first pair of rollers, and the second pair of rollers connected via a second coupling member that pivots about a second common axis between the second pair of rollers; and
pivoting the first coupling member about the first common axis to a first position among a plurality of first positions and pivoting the second coupling member about the second common axis to a second position among a plurality of second positions based on the media type identified at the graphical user interface of the printing system;
wherein when the first pair of rollers are in the first position the first pair of rollers do not contact the web, and when the second pair of rollers are in the second position the second pair of rollers contact the web.

30. A non-transitory computer readable medium embodying programmed instructions which, when executed by a processor, are operable to perform a method comprising:
receiving input at a graphical user interface of a printing system that identifies a media type for a web of continuous-forms print media that is to travel through a first pair of rollers positioned on opposite sides of the web and a second pair of rollers positioned on the opposite sides of the web, the first pair of rollers connected via a first coupling member that pivots about a first common axis between the first pair of rollers, and the second pair of rollers connected via a second coupling member that pivots about a second common axis between the second pair of rollers; and
pivoting the first coupling member about the first common axis to a first position among a plurality of first positions and pivoting the second coupling member about the second common axis to a second position among a plurality of second positions based on the media type identified at the graphical user interface of the printing system;
wherein when the first pair of rollers are in the first position the first pair of rollers do not contact the web, and when the second pair of rollers are in the second position the second pair of rollers contact the web.
